(19) United States
(12) Patent Application Publication
(10) Pub. No.: US 2014/0185209 A1
(43) Pub. Date: Jul. 3, 2014

(54) CONTAINER DATA CENTER WITH SERVER CABINET ASSEMBLY

(71) Applicant: HON HAI PRECISION INDUSTRY CO., LTD., New Taipei (TW)

(72) Inventor: CHIA-CHEN LEE, New Taipei (TW)

(73) Assignee: HON HAI PRECISION INDUSTRY CO., LTD., New Taipei (TW)

(21) Appl. No.: 13/851,967

(22) Filed: Mar. 28, 2013

(30) Foreign Application Priority Data
Dec. 28, 2012 (TW) 101150762

(51) Int. Cl. G06F 1/18

(52) U.S. Cl. CPC G06F 1/182
USPC 361/679.02

(57) ABSTRACT

A container data center includes a container and a number of server cabinets received in the container. The container includes two opposite side plates. The server cabinets are arranged in a row perpendicular to the side plates. A connection pole is formed on each of opposite sides of each server cabinet. A connection pole is formed on an inner surface of each side plate. A damper is connected between every two neighboring connection poles.

### BACKGROUND

1. Technical Field

The present disclosure relates to a container data center.

2. Description of Related Art

Many server cabinets may be installed in a container data center. The container data center is unstable during transportation, which may cause the server cabinets inside the container collide with each other and thus damaged.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a schematic view of an embodiment of a container data center, wherein the container data center includes a plurality of dampers and a plurality of connection poles.

FIG. 2 is an enlarged view of a circled portion II of FIG. 1.

FIG. 3 is an isometric view of one of the dampers of FIG. 1.

FIG. 4 is an isometric view of one of the connection poles of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

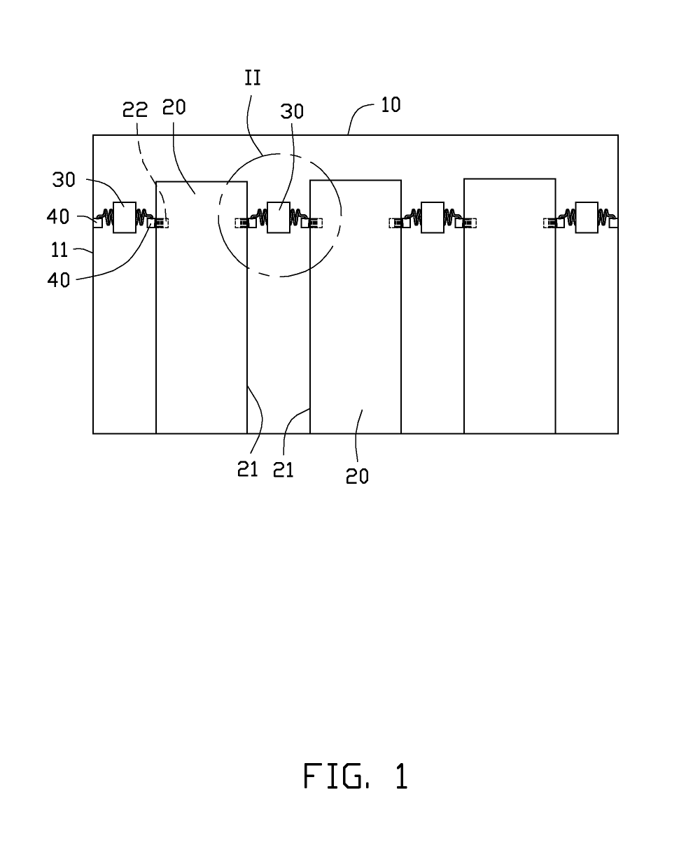

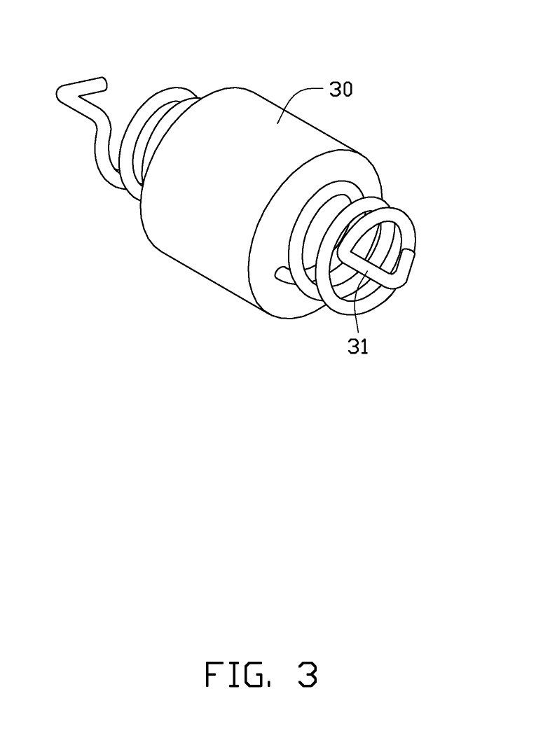

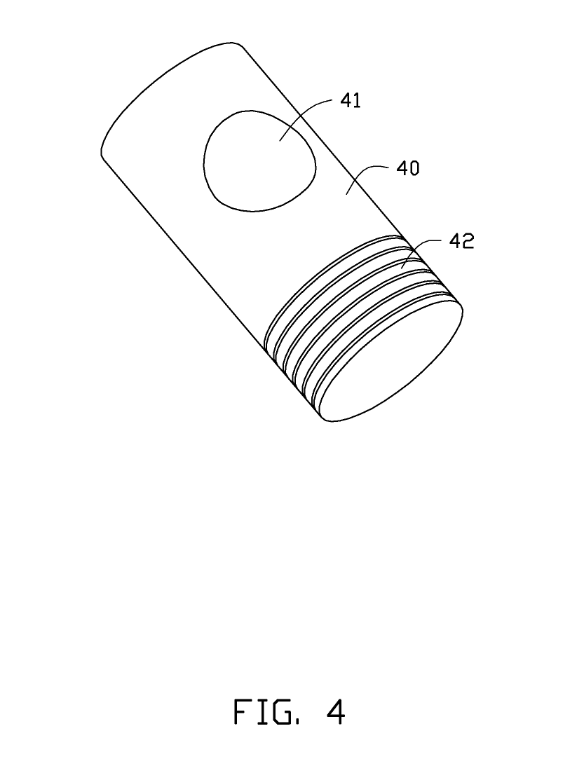

FIGS. 1, 3, and 4 show an exemplary embodiment of a container data center. The container data center includes a container 10, a plurality of server cabinets 20, a plurality of dampers 30, and a plurality of connection poles 40.

The container 10 includes two opposite side plates 11. A locking hole (not shown) is defined in an inner surface of each side plate 11. The server cabinets 20 are arranged in a row perpendicular to the side plates 11. Two outmost server cabinets 20 are near the side plates 11. Each server cabinet 20 includes two opposite sidewalls 21. Each sidewall 21 defines a mounting hole 22. Two hooks 31 extend from opposite ends of each damper 30. A through hole 41 is defined in each connection pole 40, perpendicular to a lengthwise direction of the connection pole 40. Threads are formed on a first end 42 of each connection pole 40.

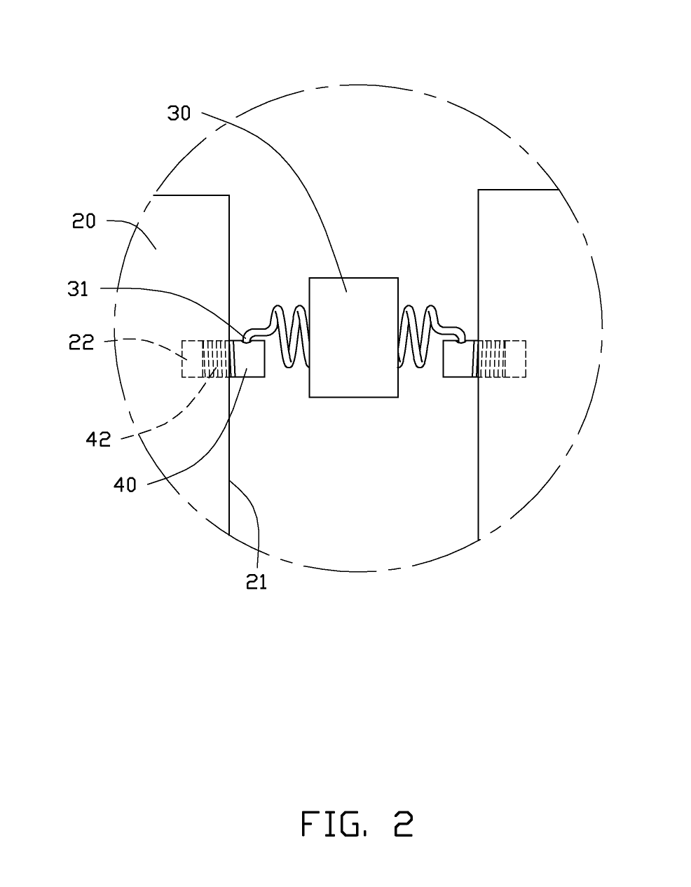

FIGS. 1 and 2 show in assembly that the first ends 42 of the connection poles 40 engage in the mounting holes 22 and the locking holes. A damper 30 is connected between every two neighboring connection poles 40. The hooks 31 of the damper 30 engage in the through holes 41 of the neighboring connection poles 40.

When the container 10 and the server cabinets 20 vibrate, the vibration energy transmits to the dampers 30 and is absorbed by the dampers 30. Thus the vibration of the container 10 and the server cabinets 20 is damped, which can prevent damage to the container 10 and the server cabinets 20.

Even though numerous characteristics and advantages of the embodiments have been set forth in the foregoing description, together with details of the structure and the functions of the embodiments, the disclosure is illustrative only, and changes may be made in details, especially in the matters of shape, size, and arrangement of parts within the principles of the embodiments to the full extent indicated by the broad general meaning of the terms in which the appended claims are expressed.

What is claimed is:

1. A server cabinet assembly, comprising:
a plurality of server cabinets arranged in a row;
a connection pole formed on a side of each server cabinet toward a neighboring one of the server cabinets; and
a damper connected between two neighboring connection poles of every two neighboring server cabinets.

2. The server cabinet assembly of claim 1, wherein a through hole is defined in each connection pole, perpendicular to a lengthwise direction of the connection pole, two hooks extend from opposite ends of each damper to engage in the through holes of the corresponding connection poles.

3. A container data center, comprising:
a container comprising two opposite side plates; and
a plurality of server cabinets received in the container and arranged in a row substantially perpendicular to the side plates, a connection pole formed on each of opposite sides of each server cabinet, a connection pole formed on an inner surface of each side plate, a damper connected between every two neighboring connection poles.

4. The container data center of claim 3, wherein a through hole is defined in each connection pole, two hooks extend from opposite ends of each damper and engage in the through holes of the corresponding connection poles.
